(19) United States
(12) Patent Application Publication
(10) Pub. No.: US 2013/0255117 A1
(43) Pub. Date: Oct. 3, 2013

(54) Display Device and Method for Assembling the Same

(71) Applicant: TOP VICTORY INVESTMENTS LTD., Kowloon (HK)

(72) Inventor: Zhi-Wei Lai, Zhonghe City (TW)

(73) Assignee: Top Victory Investments Ltd., Kowloon (HK)

(21) Appl. No.: 13/663,540

(22) Filed: Oct. 30, 2012

(30) Foreign Application Priority Data
Mar. 28, 2012 (TW) 101110821

(51) Int. Cl. G09F 13/04; B23P 11/00

(52) U.S. Cl. 40/564; 29/428

(57) ABSTRACT

A display device includes an inner base shell, a backlight panel, a frame unit and an outer base shell. The inner base shell includes a base wall; a surrounding wall extending from the circumference of the base wall at an angle therewith; and, a containing space cooperatively defined by the base and the surrounding walls. The backlight panel is disposed in the containing space. The frame unit formed of plastic and fixed around the surrounding wall has an inner side surface contacting the surrounding wall; an outer side surface opposite to the inner side surface; and, a front side surface connected to front side edges of the inner and the outer side surfaces. The outer base shell covering the inner base shell and the outer side surface of the frame unit has a front opening for exposing the backlight panel and the front side surface of the frame unit.

### BACKGROUND OF THE INVENTION

1. Field of the Invention

The invention relates to a display device and, more particularly, to a display device having a backlight panel.

2. Description of the Prior Art

Conventionally, in manufacturing a display panel, the circumference of a backlight panel is surrounded and fixed by a frame of iron, and finally the frame of iron is completely covered by and not exposed from an outer shell so that the finished product has more beautiful appearance.

However, the frame has higher cost and is used as an inner component in the finished product of the backlight panel.

### SUMMARY OF THE INVENTION

Accordingly, the invention is directed to providing a lower cost display device.

The invention provides a display device including an inner base shell, a backlight panel, a frame unit and an outer base shell.

The inner base shell includes a base wall; a surrounding wall extending from the circumference of the base wall at an angle therewith; and, a containing space cooperatively defined by the base wall and the surrounding wall. The backlight panel is disposed in the containing space of the inner base shell. The frame unit is fixed around the surrounding wall. The frame unit has an inner side surface contacting the surrounding wall; an outer side surface opposite to the inner side surface; and, a front side surface connected to front side edges of the inner side surface and the outer side surface. The outer base shell covers the inner base shell and the outer side surface of the frame unit. The outer base shell has a front opening for exposing the backlight panel and the front side surface of the frame unit.

In one embodiment, the inner base shell is formed of iron so as to provide sufficient strength to retain the whole display device. The frame unit is formed of plastic.

In one embodiment, the frame unit includes a back frame fixed around the surrounding wall and having the inner side surface; and, a front frame fixed around the back frame and having the outer side surface and the front side surface.

In one embodiment, the backlight panel includes a panel body disposed in the containing space; and, a first fixing board connected to one side of the panel body. The frame unit further includes a second fixing board fixed on the first fixing board and covered by one side of the front frame.

In one embodiment, the front frame includes a fixing frame body fixed to the back frame; and, an appearance frame board vertically connected to the inner side of the fixing frame body and having the front side surface. The appearance frame board is exposed from the front opening and further has a central opening for exposing the backlight panel.

The invention is further directed to providing a method for assembling a display device.

The invention provides a method for assembling a display device including an inner base shell, a backlight panel, a back frame and a front frame, the inner base shell including a base wall; a surrounding wall extending from the circumference of the base wall at an angle therewith; and, a containing space cooperatively defined by the base wall and the surrounding wall. The method includes the following steps: (A) fixing the back frame around the surrounding wall; (B) disposing the backlight panel in the containing space; and, (C) fixing the front frame around back frame.

In one embodiment, the backlight panel includes a panel body and a first fixing board connected to one side of the panel body, and the display device further includes a second fixing board. The above-mentioned step (B) includes the following steps: (B1) disposing the panel body of the backlight panel in the containing space, and placing the first fixing board on the back frame; and, (B2) fixing the second fixing board on the first fixing board.

In one embodiment, the front frame includes a fixing frame body; and, an appearance frame board vertically connected to the inner side of the fixing frame body and having a central opening. The above-mentioned step (C) includes the following step: (C1) fixing the fixing frame body on the second fixing board and the back frame, and exposing the backlight panel from the central opening of the appearance frame board.

In one embodiment, the display device further includes an outer base shell having a front opening. The above-mentioned method, after the step (C), further includes the following step: (D) covering the inner base shell and the fixing frame body of the front frame with the outer base shell, and exposing the backlight panel and the appearance frame board of the front frame from the front opening of the outer base shell.

Compared to the conventional technology, in the invention the backlight panel is disposed in the inner base shell and then assembled with the frame unit to form a finished product, and the product itself is capable of being exposed so as to reduce cost.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention, in which:

FIG. 1 is an exploded perspective worm's-eye view of a display device according to a preferred embodiment of the invention;

FIG. 2 is an assembled diagram of the display device as shown in FIG. 1;

FIGS. 3 through 6 are diagrams illustrating a method for assembling the display device as shown in FIG. 1;

FIG. 7 is a partial enlarged diagram for illustrating the assembly of an inner base shell and a back frame of the display device; and

FIG. 8 is a partial enlarged diagram for illustrating the assembly of the inner base shell, a second fixing board and a front frame of the display device.

### DESCRIPTION OF THE PREFERRED EMBODIMENTS

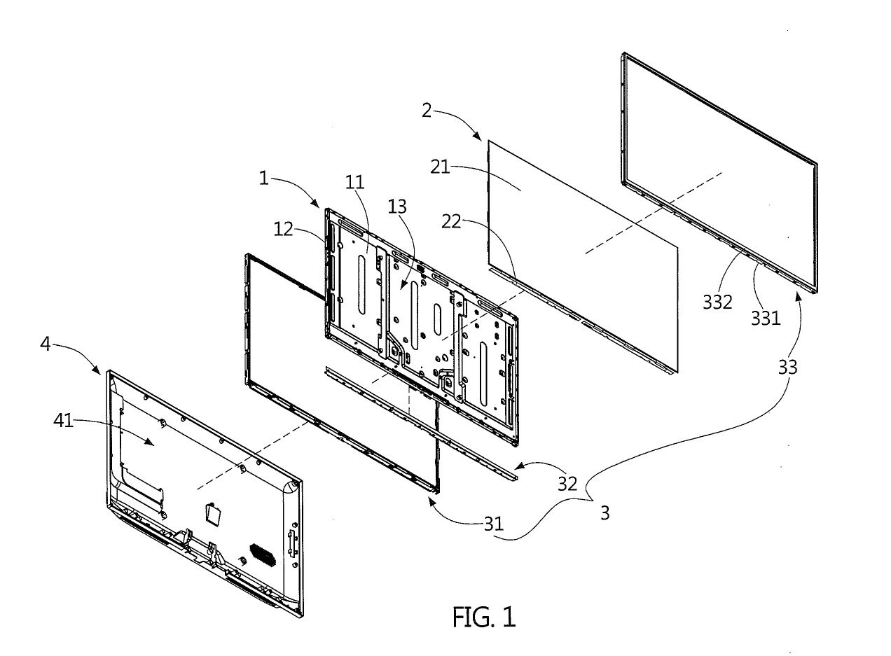

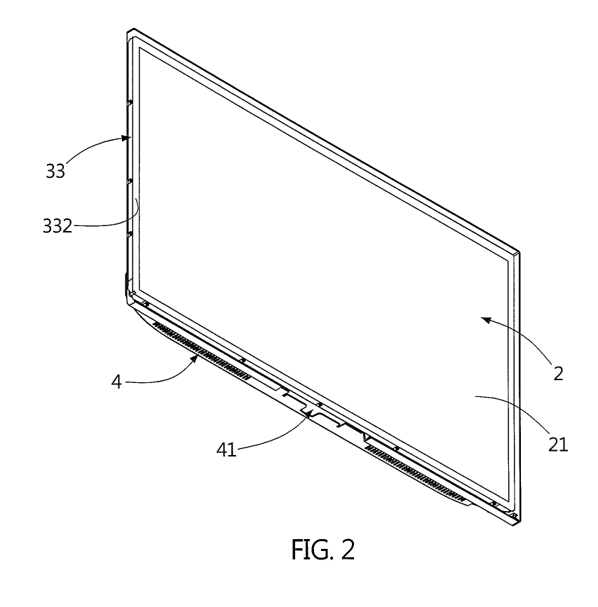

Referring to FIGS. 1 and 2, there are shown an exploded perspective worm's-eye view and an assembled diagram of a display device according to a preferred embodiment of the invention respectively. The display device includes an inner base shell 1, a backlight panel 2, a frame unit 3 and an outer base shell 4.

The inner base shell 1 is formed of iron. The inner base shell 1 includes a base wall 11; a surrounding wall 12 vertically extending from the circumference of the base wall 11; and, a containing space 13 cooperatively defined by the base wall 11 and the surrounding wall 12.

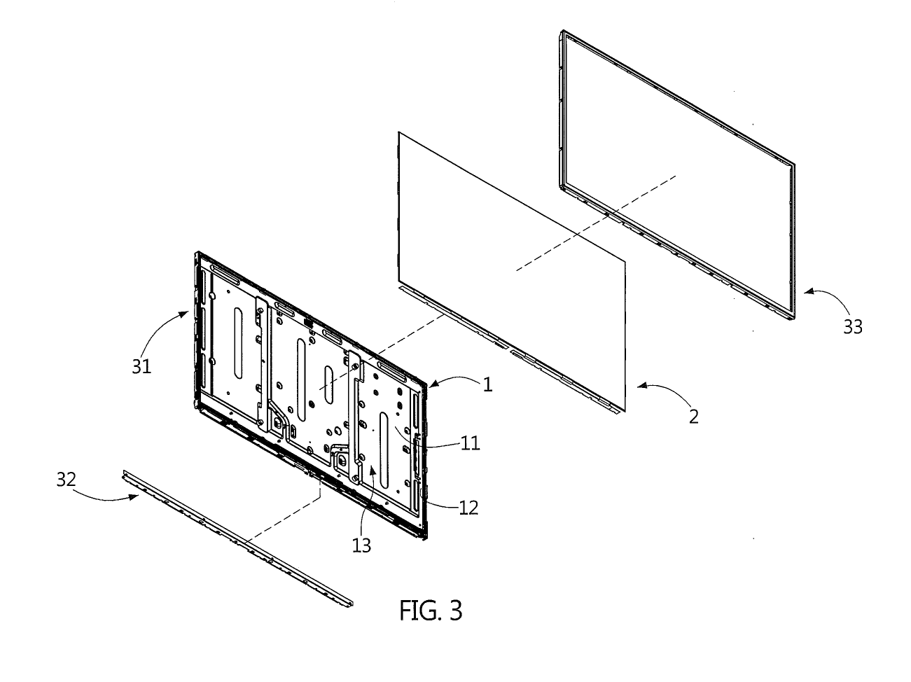

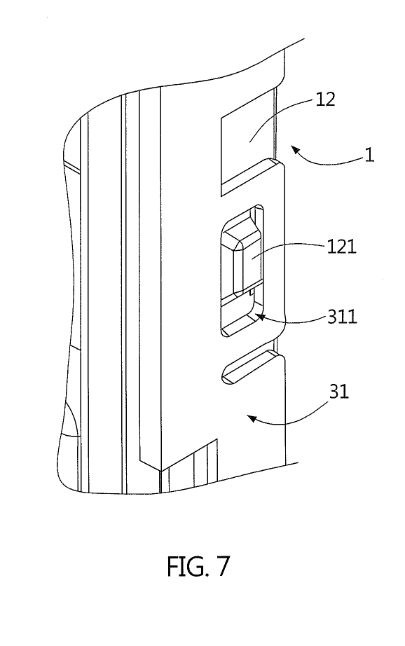

The frame unit 3 is formed of plastic. The frame unit 3 includes a back frame 31, a long strip-shaped second fixing board 32 and a front frame 33. As shown in FIG. 3, at first, the back frame 31 is fixed around the surrounding wall 12 of the inner base shell 1, and the inner side surface of the back frame 31 contacts the surrounding wall 12. Specifically, referring to FIG. 7, the surrounding wall 12 has a plurality of protrusions 121, and the back frame 31 has a plurality of through holes 311 for engaging with the corresponding protrusions 121, thereby fixing the back frame 31 to the inner base shell 1.

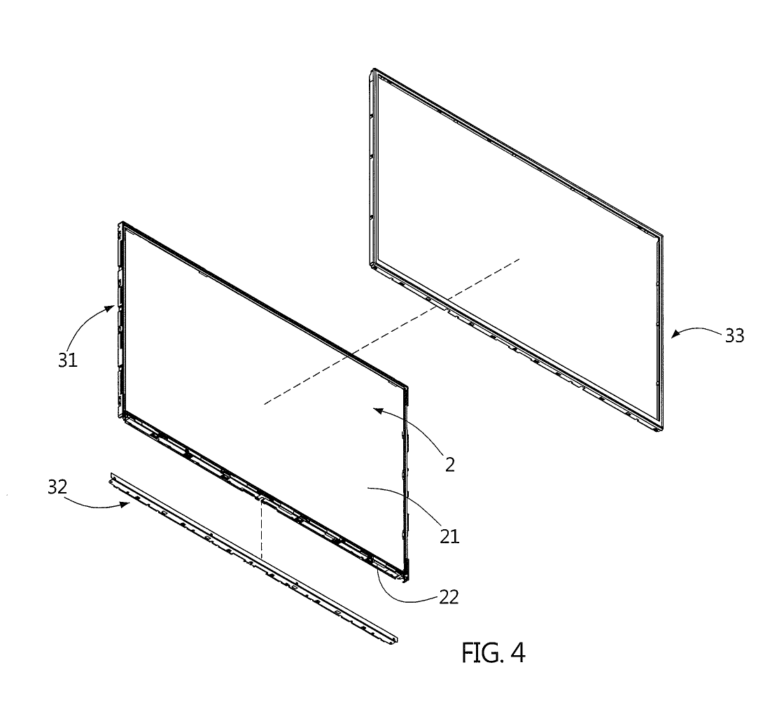

Next, as shown in FIG. 4, the backlight panel 2 includes a cuboidal display-purpose panel body 21 and a long strip-shaped first fixing board 22 connected to one side of the panel body 21. The panel body 21 of the backlight panel 2 is disposed in the containing space 13, and the long strip-shaped first fixing board 22 is placed on the back frame 31.

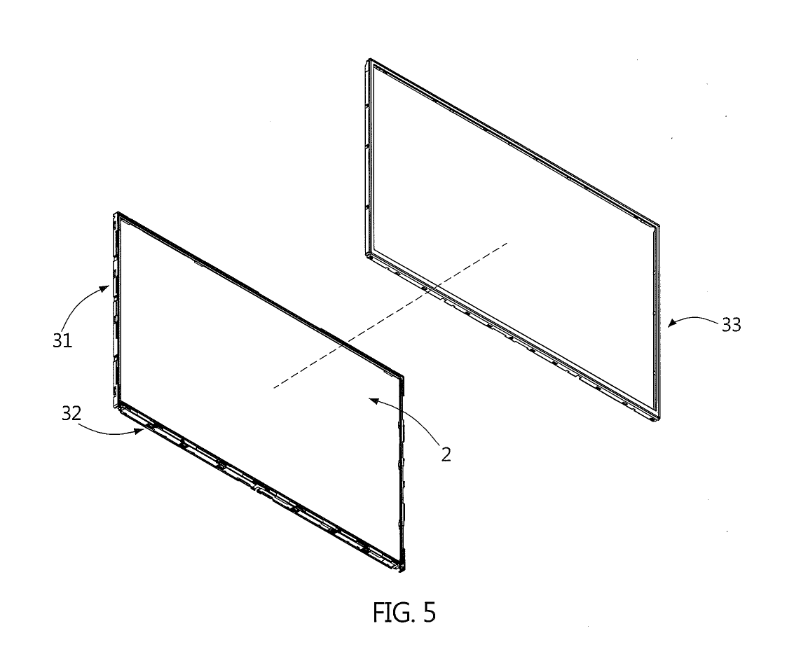

Next, as shown in FIGS. 4 and 5, the second fixing board 32 is fixed on the first fixing board 22 and cooperated with the back frame 31 to provide the fixing for the front frame 33.

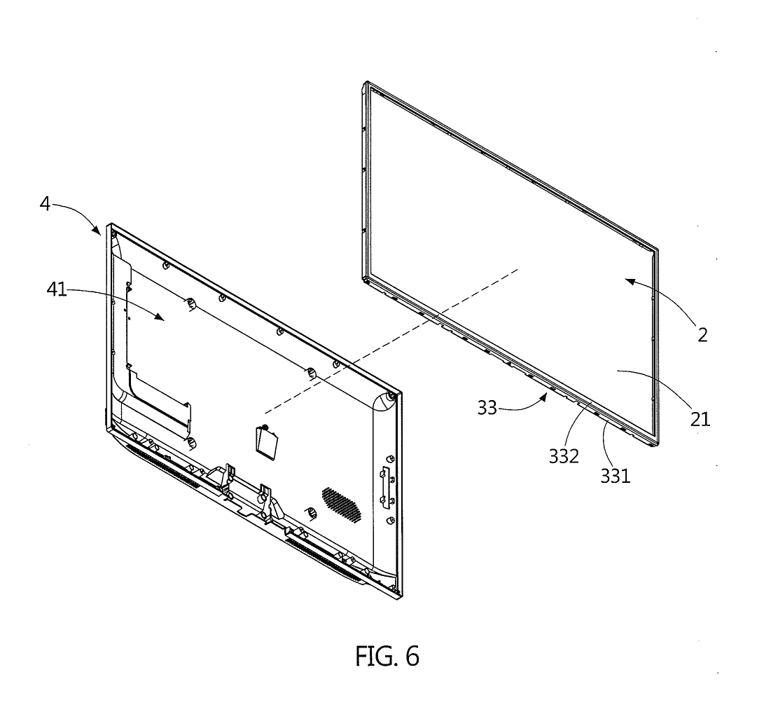

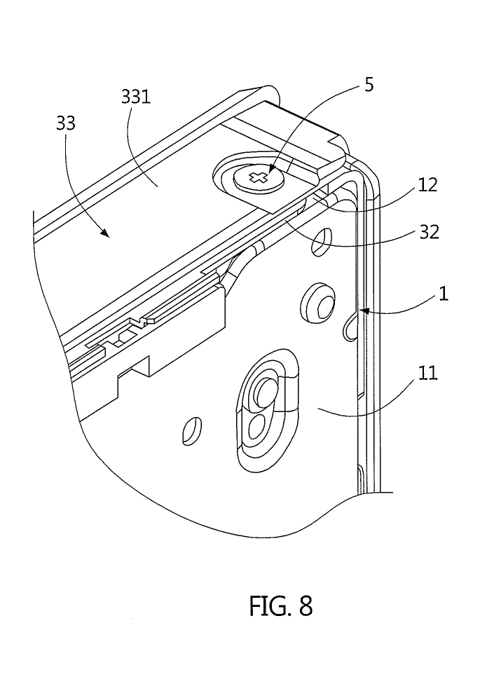

Next, as shown in FIG. 6, the front frame 33 is fixed around the second fixing board 32 and the back frame 31. Specifically speaking, the front frame 33 includes a fixing frame body 331 fixed to the back frame 31 and the second fixing board 32; and, an appearance frame board 332 vertically connected to the inner side of the fixing frame body 331. The upper side of the fixing frame body 331 covers the second fixing board 32, the three other sides of the fixing frame body 331 covers the back frame 31, and the appearance frame board 332 covers the circumference of the front side surface of the panel body 21. Referring to FIG. 8, specifically speaking, the display device further includes a plurality of screws 5. The surrounding wall 12 of the inner base shell 1, the second fixing board 32 and the fixing frame body 331 of the front frame 33 are fixed together by the screws 5.

Finally, as shown in FIGS. 2 and 6, the outer base shell 4 is attached so that the outer base shell 4 covers the base wall 11 of the inner base shell 1 and the fixing frame body 331 of the front frame 33, and the outer base shell 4 has a front opening 41 for exposing the backlight panel 2 and the appearance frame board 332 of the frame unit 3.

In summary, compared to the conventional technology, in the invention the backlight panel 2 is disposed in the inner base shell 1 and then assembled with the frame unit 3 to form a finished product, and the product itself is capable of being exposed so as to make the frame of the display device narrower to raise appearance quality and reduce cost in material.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

I claim:

1. A display device comprising:
an inner base shell comprising a base wall; a surrounding wall extending from the circumference of the base wall at an angle therewith; and, a containing space cooperatively defined by the base wall and the surrounding wall;
a backlight panel disposed in the containing space of the inner base shell;
a frame unit fixed around the surrounding wall, the frame unit having an inner side surface contacting the surrounding wall; an outer side surface opposite to the inner side surface; and, a front side surface connected to front side edges of the inner side surface and the outer side surface; and
an outer base shell covering the inner base shell and the outer side surface of the frame unit, the outer base shell having a front opening for exposing the backlight panel and the front side surface of the frame unit.

2. The display device as claimed in claim 1, wherein the inner base shell is formed of iron.

3. The display device as claimed in claim 1, wherein the frame unit is formed of plastic.

4. The display device as claimed in claim 1, wherein the frame unit comprises a back frame fixed around the surrounding wall and having the inner side surface; and, a front frame fixed around the back frame and having the outer side surface and the front side surface.

5. The display device as claimed in claim 4, wherein the backlight panel comprises a panel body disposed in the containing space; and, a first fixing board connected to one side of the panel body, the frame unit further comprises a second fixing board fixed on the first fixing board and covered by one side of the front frame.

6. The display device as claimed in claim 4, wherein the front frame comprises a fixing frame body fixed to the back frame; and, an appearance frame board vertically connected to the inner side of the fixing frame body and having the front side surface, the appearance frame board being exposed from the front opening and further having a central opening for exposing the backlight panel.

7. A method for assembling a display device comprising an inner base shell, a backlight panel, a back frame and a front frame, the inner base shell comprising a base wall; a surrounding wall extending from the circumference of the base wall at an angle therewith; and, a containing space cooperatively defined by the base wall and the surrounding wall, the method comprising the following steps:
(A) fixing the back frame around the surrounding wall;
(B) disposing the backlight panel in the containing space; and
(C) fixing the front frame around back frame.

8. The method as claimed in claim 7, wherein the backlight panel comprises a panel body and a first fixing board connected to one side of the panel body, the display device further comprises a second fixing board, the step (B) comprises the following steps:
(B1) disposing the panel body of the backlight panel in the containing space, and placing the first fixing board on the back frame; and
(B2) fixing the second fixing board on the first fixing board.

9. The method as claimed in claim 8, wherein the front frame comprises a fixing frame body; and, an appearance frame board vertically connected to the inner side of the fixing frame body and having a central opening, the step (C) comprises the following step:
(C1) fixing the fixing frame body on the second fixing board and the back frame, and exposing the backlight panel from the central opening of the appearance frame board.

10. The method as claimed in claim 9, wherein the display device further comprises an outer base shell having a front opening, the method, after the step (C), further comprises the following step:
(D) covering the inner base shell and the fixing frame body of the front frame with the outer base shell, and exposing the backlight panel and the appearance frame board of the front frame from the front opening of the outer base shell.
